(19) United States
(12) Patent Application Publication
(10) Pub. No.: US 2007/0217127 A1
(43) Pub. Date: Sep. 20, 2007

(54) Intelligent power supply

(75) Inventor: Chun-Wei Pan, Lujhu Township (TW)

Correspondence Address: RABIN & Berdo, PC, 1101 14TH STREET, NW, SUITE 500, WASHINGTON, DC, 20005, US

(73) Assignee: Channel Well Technology Co., Ltd., Taoyuan Hsien (TW)

(21) Appl. No.: 11/712,984

(22) Filed: Mar. 2, 2007

(30) Foreign Application Priority Data
Mar. 6, 2006 (TW) 95203661

(51) Int. Cl. H02B 1/00

(52) U.S. Cl. 361/601

(57) ABSTRACT

An intelligent power supply is described. The intelligent power supply includes a case, a circuit board, a fan, a detecting module, and an alarm module. The circuit board transforms an alternating current from a main supply to a direct current for an electronic equipment. The fan reduces the operating temperature of the intelligent power supply and can also reduce the operating temperature of the electronic equipment. The detecting module detects the operating status of the intelligent power supply and the alarm module sends out an alarm signal when the operating status is abnormal.

### RELATED APPLICATIONS

The present application is based on, and claims priority from, Taiwan Application Serial Number 95203661, filed Mar. 6, 2006, the disclosure of which is hereby incorporated by reference herein in its entirety.

### FIELD OF THE INVENTION

The present invention generally relates to an intelligent power supply. More particularly, this invention relates to an intelligent power supply for a computer system.

### BACKGROUND OF THE INVENTION

Science and technology are both highly developed now. Electronic equipment, like for example, the electrical household appliances and computers, have become increasingly popular and used more and more. Most of the electronic components of the electronic equipment are driven by direct current but the city power company normally provides alternating current to private homes. Therefore, some of the electronic equipment use batteries to provide electrical power to the electronic components thereof. However, most electronic equipment has to transform the alternating current from the main supply into a direct current with an internal or external power supply.

According to the circuit classification, the power supply can be divide into a linear power supply and a switching power supply. The advantages of a simple linear power supply composed of transformers, diode rectifiers and capacitor filter include high stability, fast response time, high reliability, simple circuits, small ripples, and low electromagnetic interference. However, the linear power supply is difficult to install on a circuit board because linear power supplies are usually heavy and occupy a large volume. In addition, the low converting efficiency, about 30˜50%, and no direct current input are both the shortcomings thereof.

The advantages of the switching power supply include a high converting efficiency, low power consumption, lightweight, and direct current input. Therefore, although the circuit of the switching power supply is more complicated than that of the linear power supply and the ripples and electromagnetic interference thereof are also higher than the linear power supply, the switching power supply is still better than the linear power supply as a whole. Accordingly, the switching power supply is the main stream of the power supply and is occupied most of the market.

However, the stability of a power supply is very important. If an unusual loading or the temperature increases suddenly, both the power supply and the electronic equipment using the power supply can be damaged.

### SUMMARY OF THE INVENTION

One object of the present invention is to provide an intelligent power supply able to warn the user to efficiently eliminate a defect occurred on the intelligent power supply so as to effectively protect an electronic equipment with the intelligent power supply.

Another object of the present invention is to provide an intelligent power supply able to effectively warn the user with a buzzer and/or a display to provide an enough time for the user to eliminate a defect occurred on the intelligent power supply so as to prevent the intelligent power supply and the electronic equipment from damage.

To achieve these and other advantages and in accordance with the purpose of the present invention, as embodiment and broadly described herein, the present invention provides an intelligent power supply that includes a case, a circuit board, a fan, a detecting module and an alarm module. The circuit board, fan, detecting module and alarm module are all disposed in the case. The circuit board transforms an input power, for example, an alternating current from a city main supply, into an output power, for example, a direct current, of the electronic equipment. The fan can reduce the operating temperature of the intelligent power supply, and further reduce an operating temperature of the electronic equipment. The detecting module can detect the operating status of the intelligent power supply and the alarm module sends out an alarm signal when the detecting module detects an unusual operating status occurring on the intelligent power supply.

The detecting module can be a temperature detector to detect the operating temperature of the intelligent power supply, a voltage detector to detect the operating voltage of the intelligent power supply, a current detector to detect the operating current of the intelligent power supply and/or a tachometer to detect the rotational speed of the fan of the intelligent power supply. The alarm module can be a buzzer, a display and/or a light-emitting diode displaying apparatus.

The intelligent power supply utilizes the detecting module to detect the temperature, voltage, current and/or fan rotational speed thereof. If the detectors detect the operating status of the intelligent power supply is under unexpected conditions, the alarm module sends out an alarm signal immediately. Hence, the intelligent power supply can effectively prevent itself from damage and further prevent the electronic equipment from damage. Accordingly, the intelligent power supply and the electronic equipment with the intelligent power supply can be operated safer.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a schematic view of a preferred embodiment of an intelligent power supply according to the present invention; and

FIG. 2 is a block diagram of an intelligent power supply according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

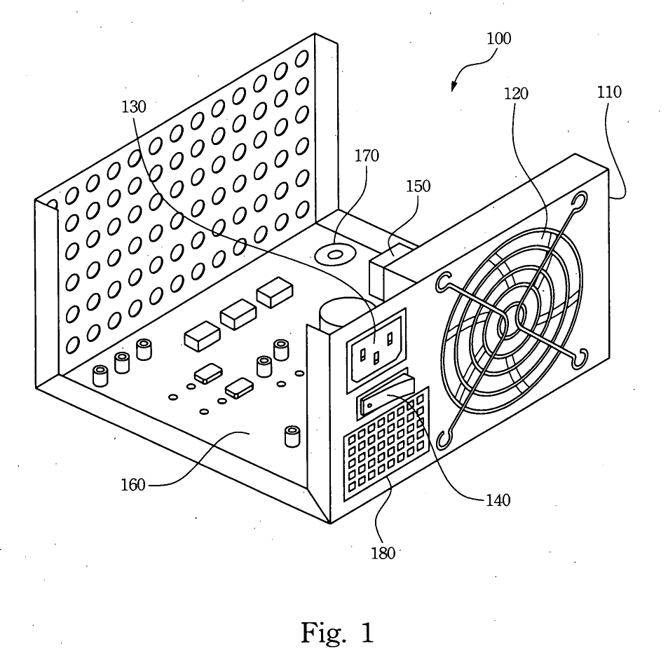

FIG. 1 illustrates a schematic view of a preferred embodiment of an intelligent power supply according to the present invention. The intelligent power supply 100 includes a case 110, a fan 120, a socket 130, a switch 140, a detecting module 150, a circuit board 160 and a buzzer 170. The circuit board 160 transforms the electrical power supplied by the socket 130, e.g. an alternating current from a main supply, into a direct current for the electronic equipment. The fan 120 reduces the internal temperature of the intelligent power supply 100, and the switch 140 turns the intelligent power supply 100 on or off.

The intelligent power supply 100 can further include a detecting module 150 to detect the operating status of the intelligent power supply 100, for example, the status of the operating current and/or voltage of the intelligent power supply 100, the status of the fan and/or the internal temperature of the intelligent power supply 100. The intelligent power supply 100 can warn the user through the buzzer 170 about the foregoing unusual operating status when any one of the foregoing unusual operating statuses is detected by the detecting module 150. Therefore, the user can get enough time to eliminate the unusual operating status rather than wait for a breakdown on the power supply.

When the power supply breaks down, the electronic equipment can also breaks down. In addition, the electronic equipment may be damages by the power supply breakdown. Hence, the user can save the electronic equipment, for example, a computer, from being damaged with the prediction of the intelligent power supply 100. That is, when the detecting module 150 detects an unusual operating status on the intelligent power supply 100, the buzzer 170 can immediately warn the user to eliminate the unusual conditions to prevent the intelligent power supply 100 and the electronic equipment with the intelligent power supply 100 from further damage.

The detecting module 150 can be a temperature sensor, a voltage detector, a current detector, a tachometer of the fan, and so on. The intelligent power supply 100 may further include a display 180 or a display composed of light-emitting diodes to inform the user the details of the unusual status occurred on the intelligent power supply 100.

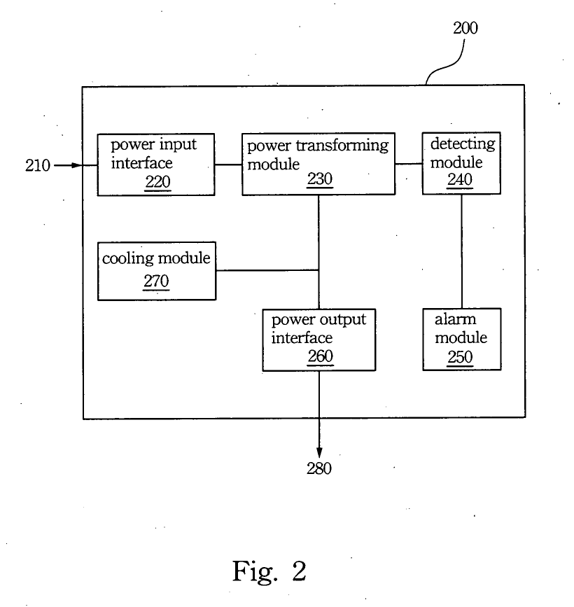

FIG. 2 is a block diagram of an intelligent power supply according to the present invention. The intelligent power supply 200 includes a power input interface 220, a power transforming module 230, a detecting module 240, an alarm module 250, a power output interface 260 and cooling module 270. An input power 210 is inputted into the intelligent power supply 200 through the power input interface 220 and transformed into a desired output power 280 by the power transforming module 230. The output power 280 is subsequently transmitted to an electronic equipment, e.g. a computer, through the power output interface 260. The cooling module 270 can reduce the operating temperature of the intelligent power supply 200 and also reduce the operating temperature of the electronic equipment, e.g. the computer.

The detecting module 240 detects the internal status of the intelligent power supply 200 and the alarm module 250 warns the user if an unusual status is detected by the detecting module 240.

The intelligent power supply 100 according to the present invention can warn the user in advance when the power supply operation is abnormal so as to effectively provide enough time for the user to eliminate the unusual status rather than wait for the power supply to be damaged. The user can know about the occurrence of the unusual status in the power supply in advance rather than after the power supply is damaged. Hence, the electronic equipment, e.g. the computer, with the intelligent power supply according to the present invention can be operated more smoothly and stably to effectively prevent the electronic components and the recorded data from damage.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. An intelligent power supply, comprising:
a case;
a circuit board disposed in the case to transform an input power into an output power;
a fan disposed in the case and connected to the circuit board to reduce an operating temperature of the intelligent power supply;
a detecting module disposed in the case and connected to the circuit board to detect an operating status of the intelligent power supply; and
an alarm module disposed in-the case and connected to the circuit board to send out an alarm signal when the detecting module detects an unusual operating status occurring on the intelligent power supply.

2. The intelligent power supply of claim 1, wherein the input power is an alternating current from a main supply.

3. The intelligent power supply of claim 2, wherein the output power is a direct current.

4. The intelligent power supply of claim 1, wherein the detecting module comprises a temperature detector to detect the operating temperature of the intelligent power supply.

5. The intelligent power supply of claim 1, wherein the detecting module comprises a voltage detector to detect an operating voltage of the intelligent power supply.

6. The intelligent power supply of claim i, wherein the detecting module comprises a current detector to detect an operating current of the intelligent power supply.

7. The intelligent power supply of claim 1, wherein the detecting module comprises a tachometer to detect a rotational speed of the fan.

8. The intelligent power supply of claim 1, wherein the alarm module comprises a buzzer.

9. The intelligent power supply of claim 1, wherein the alarm module comprises a display.

10. The intelligent power supply of claim 1, wherein the alarm module comprises a display composed of light-emitting diodes.

11. An intelligent power supply, comprising:
a case;
a circuit board disposed in the case to transform an alternating current from a main supply into a direct current output power for an electronic equipment;
a fan disposed in the case and connected to the circuit board to reduce an operating temperature of the intelligent power supply and an operating temperature of the electronic equipment;
a detecting module disposed in the case and connected to the circuit board to detect an operating status of the intelligent power supply; and
an alarm module disposed in the case and connected to the circuit board to send out an alarm signal when the detecting module detected an unusual operating status occurred on the intelligent power supply.

12. The intelligent power supply of claim 11, wherein the detecting module comprises a temperature detector to detect the operating temperature of the intelligent power supply.

13. The intelligent power supply of claim 11, wherein the detecting module comprises a voltage detector to detect an operating voltage of the intelligent power supply.

14. The intelligent power supply of claim 11, wherein the detecting module comprises a current detector to detect an operating current of the intelligent power supply.

15. The intelligent power supply of claim 11, wherein the detecting module comprises a tachometer to detect a rotational speed of the fan.

16. The intelligent power supply of claim 11, wherein the alarm module comprises a buzzer.

17. The intelligent power supply of claim 11, wherein the alarm module comprises a display.

18. The intelligent power supply of claim 11, wherein the alarm module comprises a display composed of light-emitting diodes.

19. An intelligent power supply, comprising:
a case;
a circuit board disposed in the case to transform an alternating current from a main supply into a direct current output power for an electronic equipment;
a fan disposed in the case and connected to the circuit board to reduce an operating temperature of the intelligent power supply and an operating temperature of the electronic equipment;
a detecting module disposed in the case and connected to the circuit board to detect the operating temperature of the intelligent power supply; and
a buzzer disposed in the case and connected to the circuit board to send out an alarm signal when the detecting module detects an unusual operating temperature of the intelligent power supply.

20. The intelligent power supply of claim 19, further comprising:
a voltage detector to detect an operating voltage of the intelligent power supply;
a current detector to detect an operating current of the intelligent power supply; and
a tachometer to detect a rotational speed of the fan, wherein the buzzer sends out the alarm signal when a unusual operating voltage, a unusual operating current or a unusual rotational speed is detected.
